(19) United States
(12) Patent Application Publication
(10) Pub. No.: US 2016/0304244 A1
(43) Pub. Date: Oct. 20, 2016

(54) PORTABLE FLUID TANK AND METHOD OF MAKING SAME

(71) Applicant: 2454223 Ontario Inc. operating as Handy Hydrant, Porcupine (CA)

(72) Inventor: Brian NANKERVIS, Porcupine (CA)

(21) Appl. No.: 15/075,500

(22) Filed: Mar. 21, 2016

Related U.S. Application Data
(60) Provisional application No. 62/148,789, filed on Apr. 17, 2015.

(51) Int. Cl. B65D 21/08; B65D 51/16; B31B 45/00

(52) U.S. Cl. CPC B65D 21/086; B31B 45/00; B65D 51/1644

(57) ABSTRACT

A portable fluid tank made from a flexible accordion duct tube and a method of make same is disclosed. The method comprises cutting a length of impermeable flexible accordion duct hose; attaching a cap to each end of the length of hose, at least one cap having a coupling for receiving a smaller tube in sealed engagement; and sealing the caps to the hose.

### TECHNICAL FIELD

The present disclosure relates to a portable fluid tank.

### BACKGROUND

Portable water tanks are used by municipal and wild land fire-fighters in areas where fire hydrants are not available as a reserve supply of water from which tankers can refill their tanks. The potable water tanks are filled from firetrucks, lakes or streams.

One existing type of portable water tank is an unsupported or onion tank, an example of which is shown in FIGS. 1 and 2. As can be seen in FIGS. 1 and FIG. 2, a problem with this type of tank is that it must be on a level surface or water will spill out of the lower side of the tank.

Another existing type of portable water tank is a framed tank (shown in FIG. 3). This type of tank can be heavy due to the extra weight of the frame and difficult for one person to set up. Usually, the frame needs to be assembled once the site for the tank is chosen. The sites has to be level and thus, these tanks are often set up on road which can in some cases block the roadway. Fitting all of the components of the frame together best done with at least three people. The set up can also be time consuming.

Hard shell portable fluid tanks also exist and examples are shown in FIGS. 4 and 5. These can be very heavy and are generally left on the vehicle used to transport them as they are difficult to manoeuvre.

### SUMMARY

In one aspect, there is provided a method of making a portable fluid tank, the method comprising: cutting a length of water-proof flexible accordion duct hose; attaching a cap to each end of the length of hose, at least one cap having a coupling for receiving a smaller tube in sealed engagement; and sealing the caps to the hose.

### BRIEF DESCRIPTION OF THE DRAWINGS

FIGS. 1 to 5 are line diagrams of existing portable water tanks;

FIG. 6 is a line diagram of a portable fluid tank in accordance with one example embodiment of the present disclosure;

FIG. 7 is a line diagram of an end cap of a portable fluid tank in accordance with one example embodiment of the present disclosure;

FIG. 8 is a line diagram of an end cap of a portable fluid tank in accordance with one example embodiment of the present disclosure

FIG. 9 is a line diagram of a portable fluid tank in accordance with one example embodiment of the present disclosure;

FIG. 10 is a line diagram of a portable fluid tank in accordance with one example embodiment of the present disclosure;

FIG. 11 is a line diagram of a portable fluid tank in accordance with one example embodiment of the present disclosure stored in the back of a truck;

FIG. 12 is a line diagram of a portable fluid tank in accordance with one example embodiment of the present disclosure stored in the back of a truck;

FIG. 13 is a line diagram of a portable fluid tank in accordance with one example embodiment of the present disclosure stored in a carrying bag;

FIG. 14 is a line diagram of a potable fluid tank in accordance with one example embodiment of the present disclosure being carried in a backpack; and

FIG. 15 is a conversion chart showing the capacity of difference sizes of water tanks according to the present disclosure.

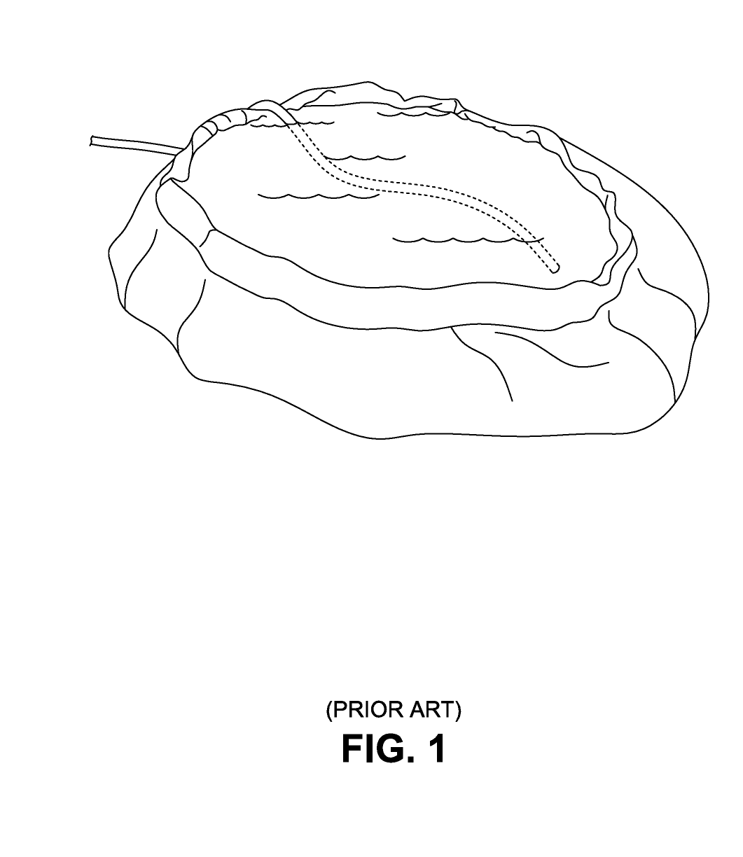

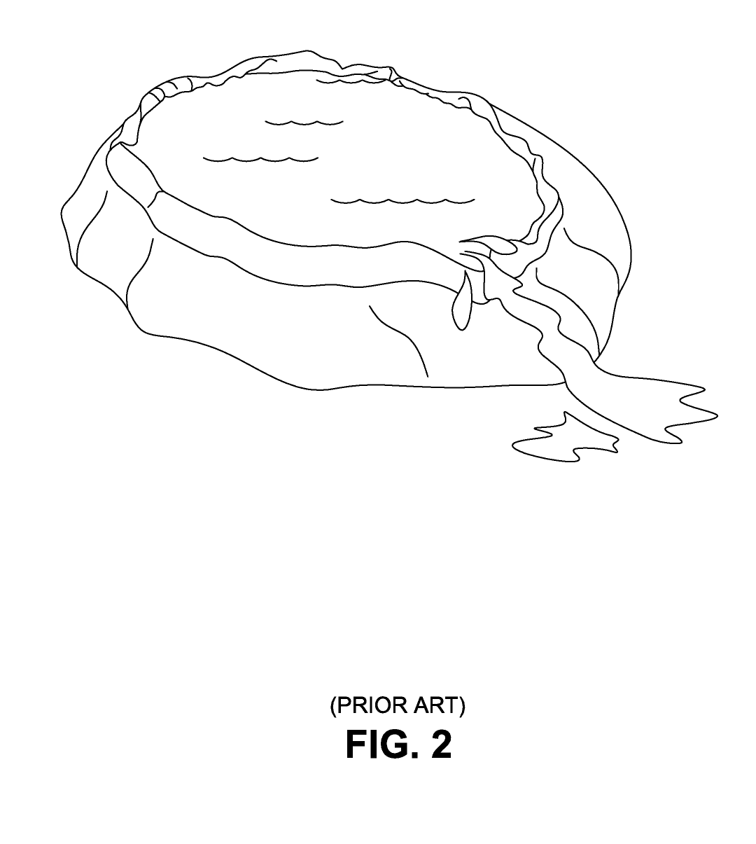

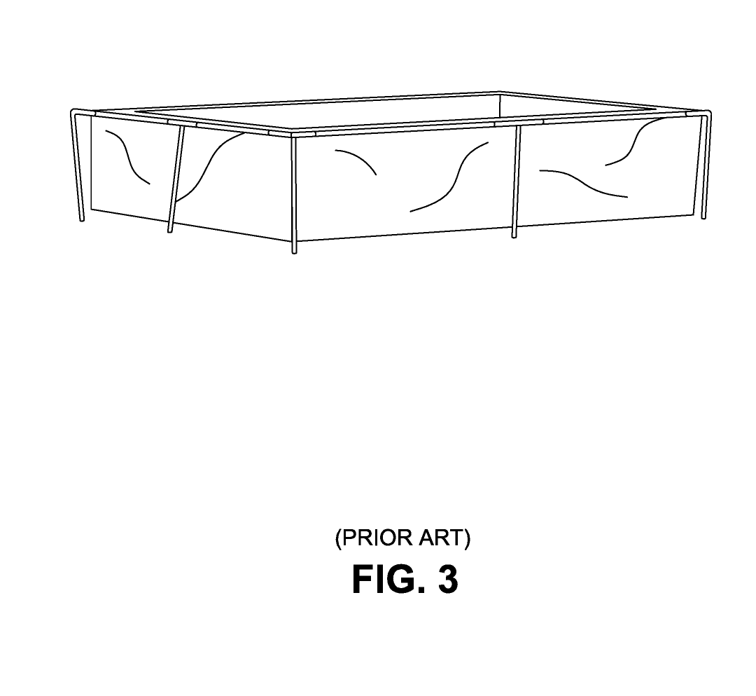

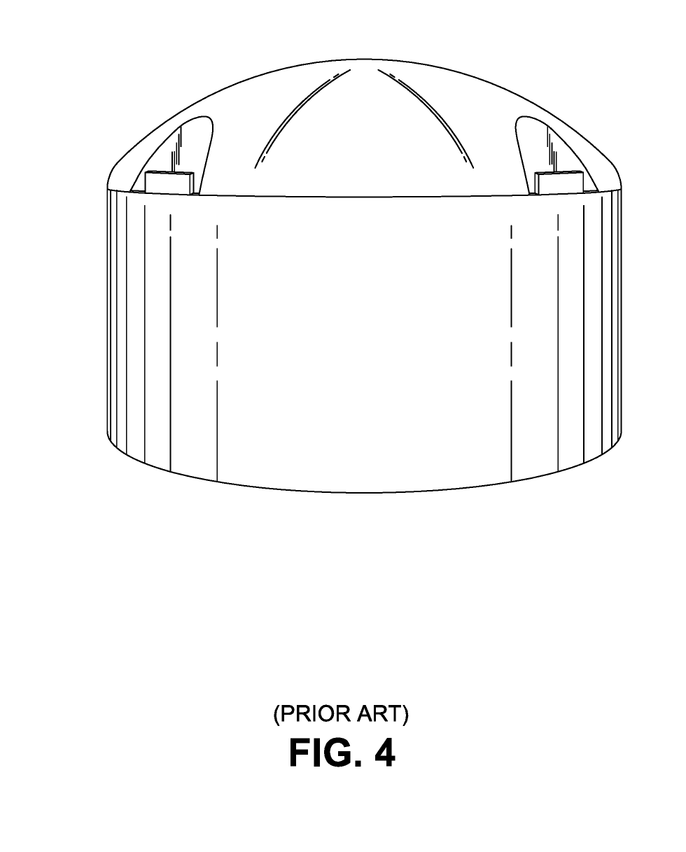

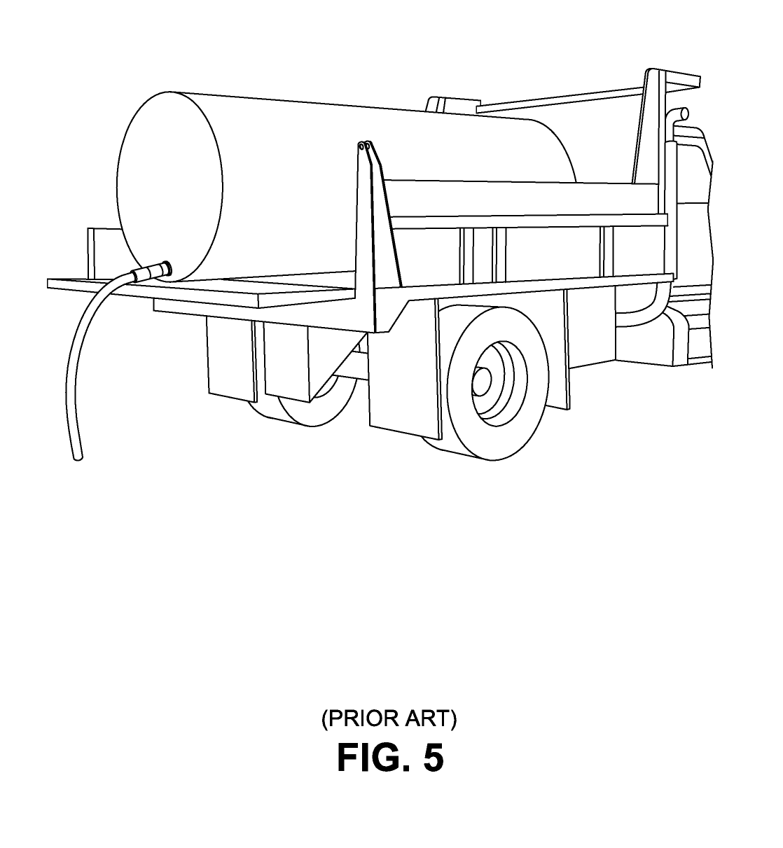

### DETAILED DESCRIPTION

To the accomplishment of the foregoing and related ends, certain illustrative aspects are described herein in connection with the following description and the annexed drawings. These aspects are indicative of the various ways in which the principles disclosed herein can be practiced. Other advantages and novel features will become apparent from the following detailed description when considered in conjunction with the drawings.

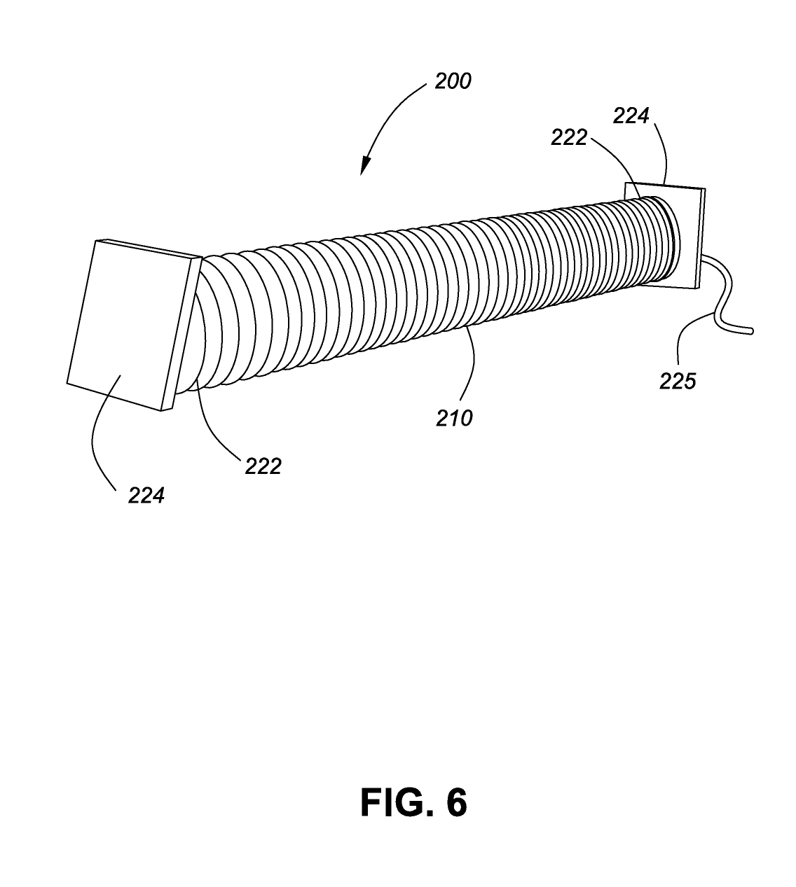

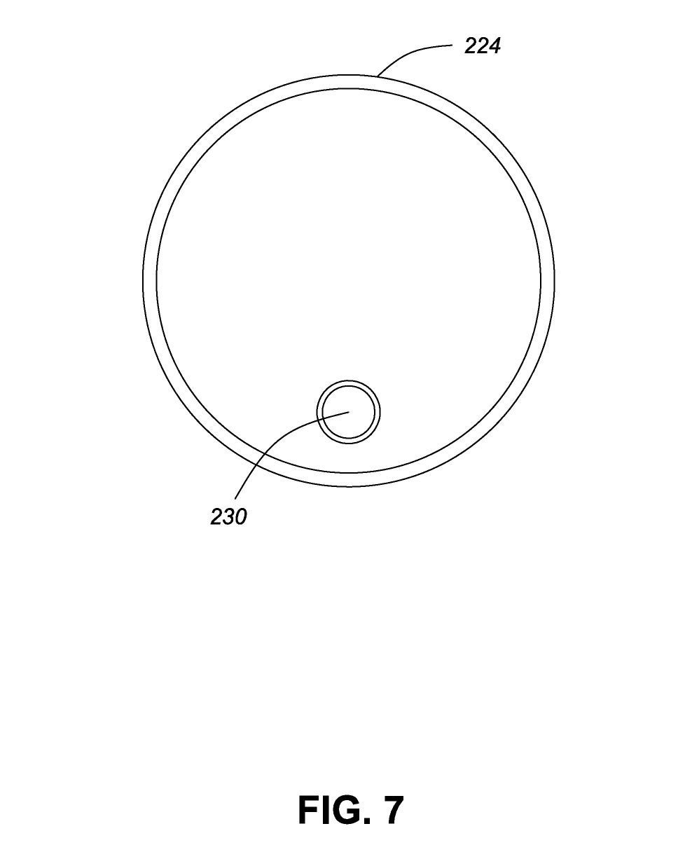

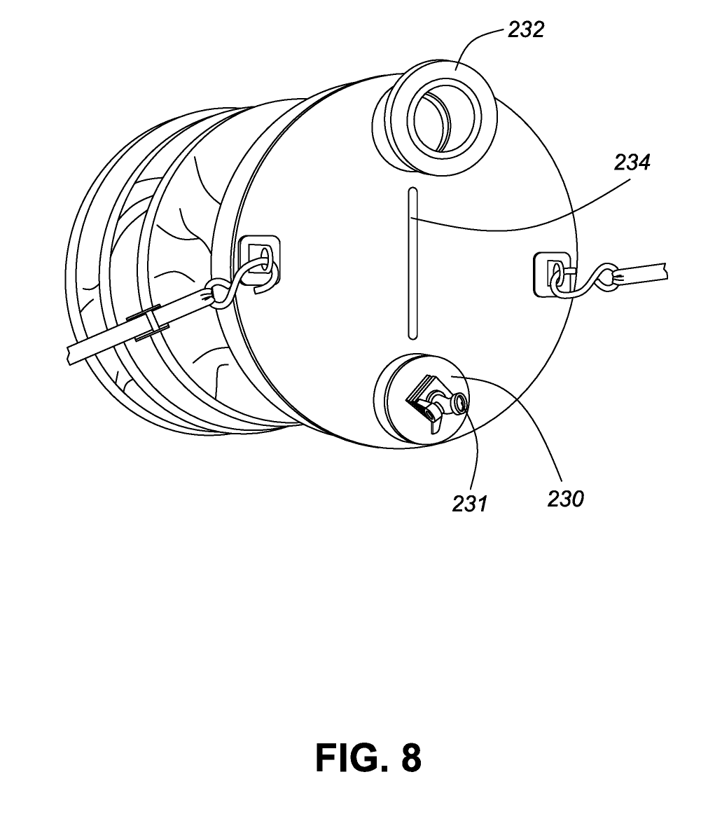

An improved portable water tank and method of making the tank has been developed. Referring to FIG. 7, the portable fluid tank 200 comprises an impermeable flexible accordion tube 210 with sealed at each end with a cap 222 and 224. At least one cap 224 has a coupling 230 (shown in FIG. 7) to which a tube can be attached. The caps 224 can be any shape provided they seal the end of the tube 210. In FIG. 6 square caps are shown and FIG. 6 is an example of a round cap. In some embodiments, there is a coupling 230 in each cap and in still other embodiments the at least one cap 224 has more than one coupling. The coupling is used to fill the tank or to take water out of the tank, for example to fill the tanks of a pumper fire truck, a lake, or a stream. In some embodiments, the coupling comprises a valve 231 (shown in FIG. 8). In some embodiments, the accordion tube 210 is water-proof. In some embodiments the accordion tub is fire-retardant.

In the embodiment of the cap 224 shown in FIG. 8, a viewing window 234 is added to permit a user to see the water level inside the tank. This embodiment also shows a second coupling 232. With two couplings, one can be used for filling the tank and the other can be used for pumping water out of the tank.

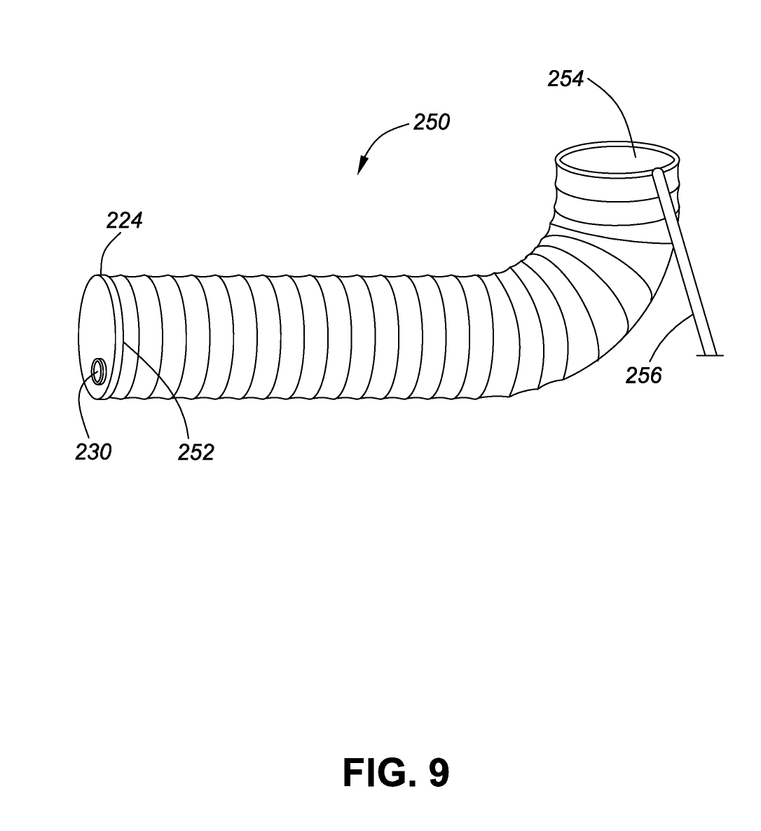

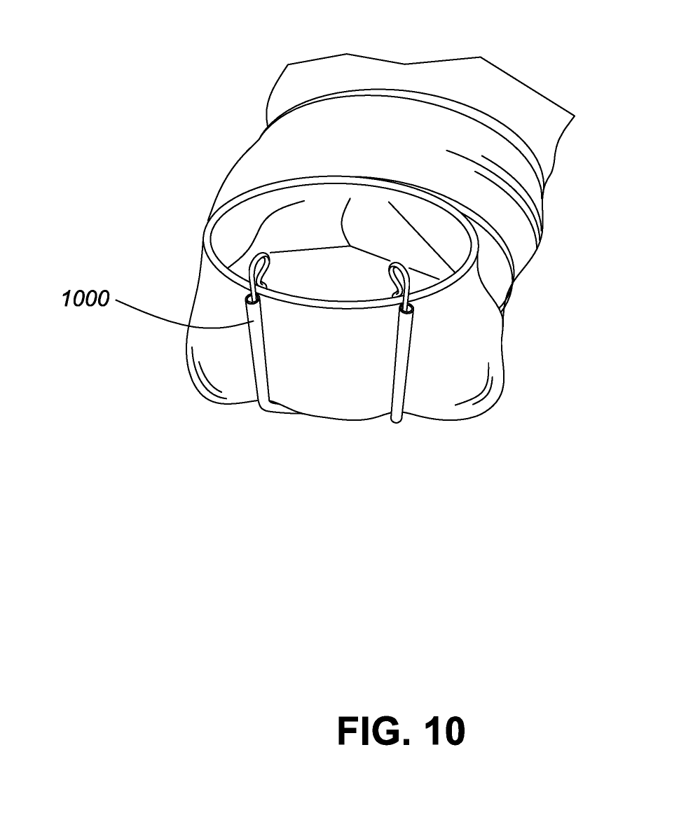

In another embodiment 250, only one end 252 is sealed with a cap 224. An example of an open-ended portable fluid tank 250 is shown FIGS. 9 and 10. In FIGS. 9 and 10, the other end 254 is bent upward when in use such that the opening is facing upward. In FIG. 9, a rod 256 can be used to curve the open end upward. In the embodiment shown in FIG. 10, a curved frame 1000 is used to hold the open end upward. The frame shown comprises two upwardly bent arms with hooks at the top to hold the lip of the opening in the accordion tube. Other configurations of the frame are possible. Any mechanical tip-up device that can hold the open end reasonably horizontal can be used. In these embodiments, the open end can be used to easily fill the tank or to empty the tank with suction.

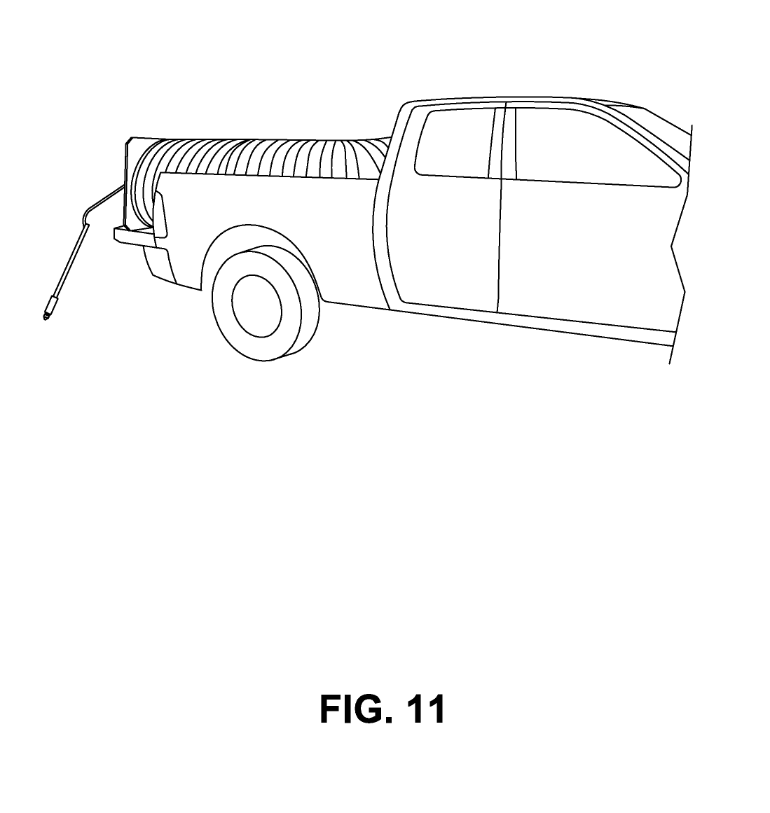

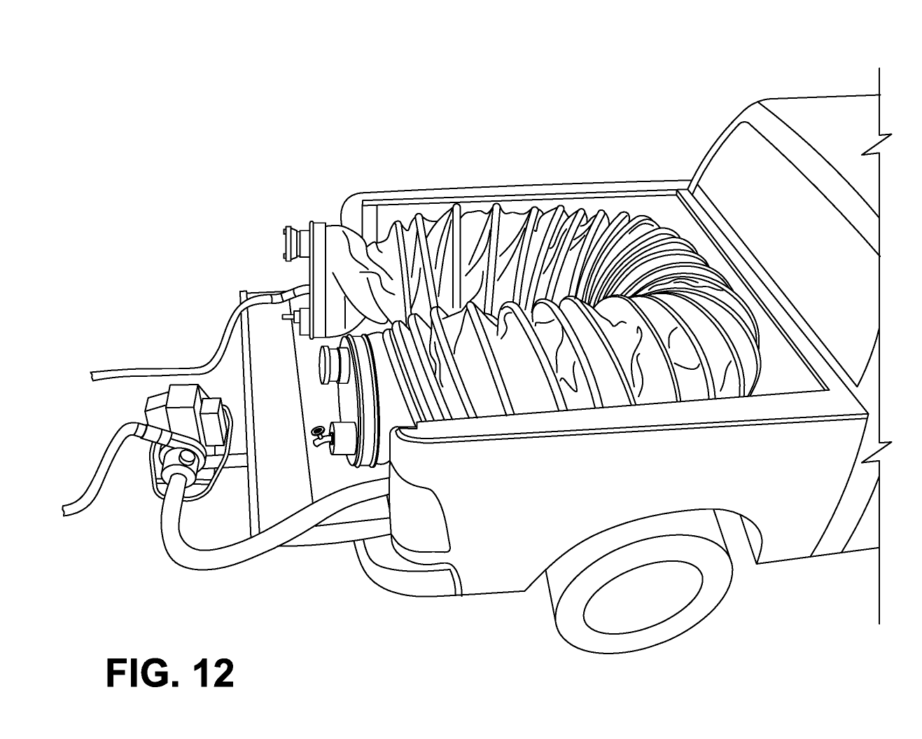

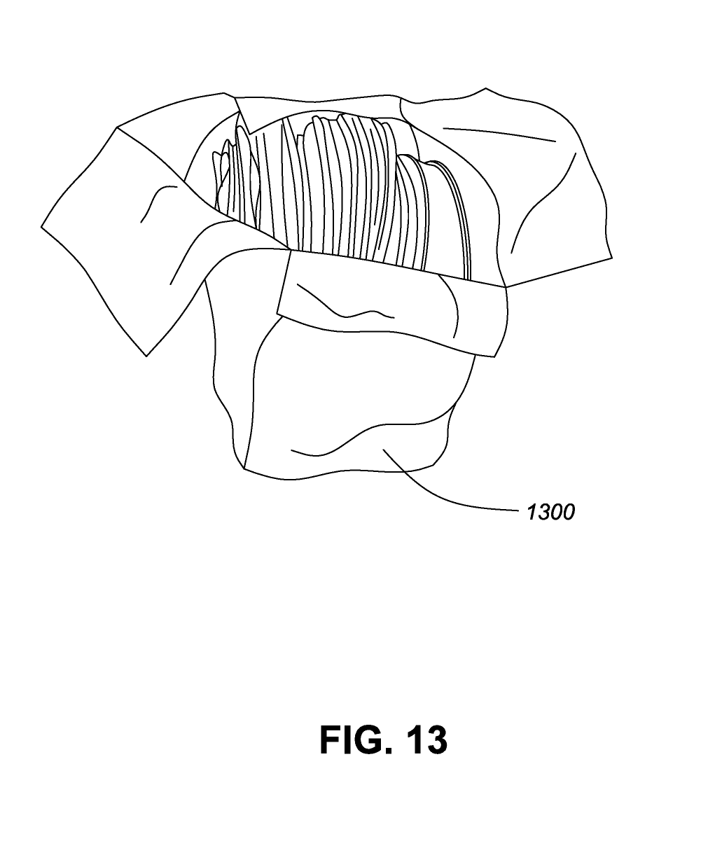

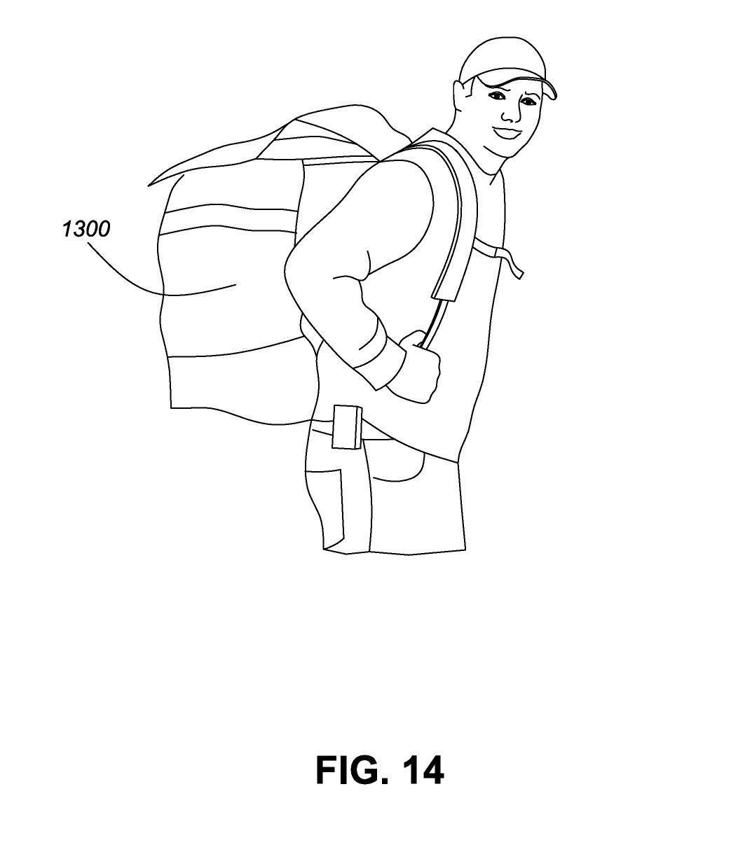

The tube can be any accordion tube as long as it is water proof. One non-limiting example is accordion ducting. Non-limiting examples of material that can be used for tube are polyurethane, PVC, Neoprene cover fabric, thermoplastic, and metal. Commercially available tubes that can be used include but are not limited to Schauenburg™ Flexible Ducting. In some embodiments, the tube can be compressed or extended lengthwise. This embodiment of the portable water tank can be transported in a smaller compressed form that can be transported in a small pick-up truck as shown in FIGS. 11 and 12 or even in a backpack 1300 as shown in FIGS. 13 and 14 and expanded on location to a larger volume when needed to be filled with water.

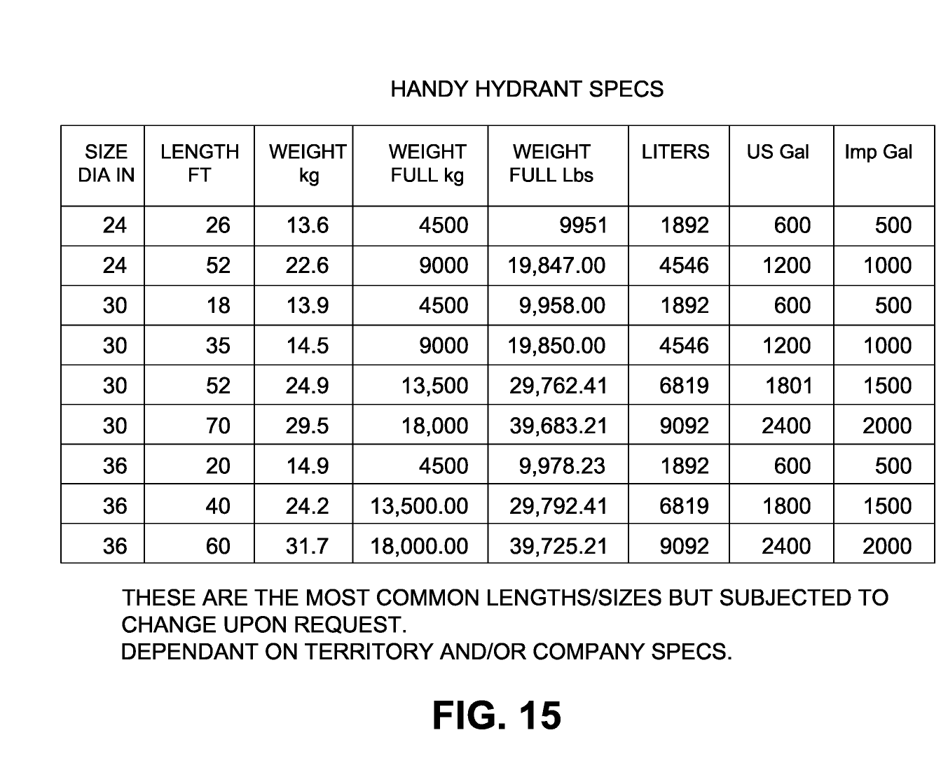

The length and diameter of the tube determine the volume of water that the tank can hold. FIG. 15 is a table that shows the approximate volume for a variety of non-limiting sizes. In the examples shown, the hoses have diameters of 24, 30 or 36 inches.

In some embodiments, the tube is flexible in all directions. The flexibility and the fact that the tank is not open at the top means that it does not have be used on level ground and it can be bent if the available space cannot accommodate the full length of the tank. The disclosed tank can be used in ditches, on trails, on roadways and on uneven ground.

The caps can be made of wood, metal (such as but not limited to aluminum), plastic, rubber or any suitable material. They can be round, oblong, square or rectangular. They can include a gasket for creating seal with the tube. They can be attached using adhesive or other suitable means, such as with a ratchet style or compression strap. In another embodiment a cloth cap is used. It can be glued or welded in place.

The couplings can be threaded couplings. In some embodiments, the couplings are chosen to mate with the couplings used by the regional fire department. For example National Fine or Course fittings can be used.

A method of making a portable fluid tank according to the present disclosure comprises cutting a length of water-proof flexible accordion tube; attaching a cap to each end of the length of hose, at least one cap having a coupling for receiving a smaller tube in sealed engagement; and sealing the caps to the tube.

While the portable fluid tanks described herein is primarily described for use by firefighters to fill fire tankers or another fire pump, it is to be understood that it can be used in any situation where a portable supply of water or any liquid compatible with the material used in the tank is required. The portable fluid tank disclosed herein can be filled with water from a body of water, such as a river or lake, or from a water-tank on a truck. The portable fluid tank can be used anywhere where water is required on a temporary basis such but not limited to firefighting (such as but not limited to urban, rural or railway firefighting), construction zones, agricultural areas, and remote communities or cottages. The tank can be used by drilling companies to store water required for cooling or lubrication. It is also possible that the fluid tank can be used for other fluids such as pesticides, fertilizers and fuels so long as the materials used for the tube and caps are compatible with the fluid stored.

The portable fluid tank can also be used in lieu of sand bags as a dike or dam to support the banks of a body of water, such as a river or lake, in order to contain the body of water in flood situations. The portable water tank can also be used to redirect water from a stream or river. Another use is to contain spills such as oil spills.

In some embodiments, the tank can be filled partially with sand or other solid material and partially with water. This will help prevent it from moving around especially when being used as a dike.

In some embodiments, an empty portable fluid tank can be used in conjunction with a light source (such as a flashlight, spotlight or floodlight) that is shone into one of the openings in one end of the tank. When a light is shone into the tank, the tank becomes a long illuminated tube. This can be used to mark off an emergency site.

The portable tank disclosed herein has many advantage, such as but not limited to:
less labour is required to transport, set up and use the disclosed tank than with existing tanks
the tank can be readjusted in use
the tank is versatile and can be installed in most locations
does not need to be on a roadway which can block traffic
the tank takes up less space when empty than existing tanks
the tank is lighter than existing tanks.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations. Furthermore, to the extent that the term “includes” is used in either the detailed description or the claims, such term is intended to be inclusive in a manner similar to the term “comprising” as “comprising” is interpreted when employed as a transitional word in a claim.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A portable fluid tank, the tank comprising:
an impermeable flexible accordion duct tube;
a first cap sealed at a first end of the tube, the cap having a coupling for receiving a hose in sealed engagement.

2. The portable fluid tank of claim 1, further comprising a second cap sealed at a second end of the tube.

3. The portable fluid tank of claim 1, further comprising a device for holding a second end of the tube at an upward angle.

4. The portable fluid tank of claim 1 wherein the tube is 24 inches in diameter.

5. The portable fluid tank of claim 1 wherein the tube is 30 inches in diameter.

6. The portable fluid tank of claim 1 wherein the tube is 36 inches in diameter.

7. The portable fluid tank of claim 1 wherein at least one of the caps is made of wood.

8. The portable fluid tank of claim 1 wherein at least one of the caps is made of metal.

9. The portable fluid tank of claim 1 wherein at least one of the caps is made of rubber.

10. The portable fluid tank of claim 1 wherein the coupling comprises a valve.

11. The portable fluid tank of claim 1 wherein the tube can be compressed or extended lengthwise.

12. The portable fluid tank of claim 1 wherein the tube is flexible in all directions.

13. The portable fluid tank of claim 1 wherein the tube is made of polyurethane.

14. The portable fluid tank of claim 1 wherein the tube is made of PVC.

15. The portable fluid tank of claim 1 wherein the tube is made of Neoprene coated fabric.

16. The portable fluid tank of claim 1 wherein the tube is made of thermoplastic.

17. The portable fluid tank of claim 1 wherein the tube is made of metal.

18. A method of making a portable fluid tank, the method comprising:
cutting a length impermeable flexible accordion duct tube;
attaching a cap to each end of the length of the tube, at least one cap having a coupling for receiving a smaller hose in sealed engagement; and
sealing the caps to the tube.

19. A kit comprising a portable fluid tank according to claim 1 and a light that can shine into the tube through the coupling.
